(19) United States
(12) Patent Application Publication
(10) Pub. No.: US 2023/0332507 A1
(43) Pub. Date: Oct. 19, 2023

(54) HYDRAULIC THRUST BEARING FOR A GAS TURBINE UNIT FOR BLADE CLEARANCE ADJUSTMENT

(71) Applicant: Siemens Energy Global GmbH & Co. KG, Munich, Bayern (DE)

(72) Inventors: Michael Kursch, Mulheim an der Ruhr (DE); Till Spielmann, Mülheim an der Ruhr (DE); Johann Stach, Mülheim an der Ruhr (DE)

(73) Assignee: Siemens Energy Global GmbH & Co. KG, Munich, Bayern (DE)

(21) Appl. No.: 18/028,530

(22) PCT Filed: Sep. 9, 2021
(86) PCT No.: PCT/EP2021/074773

§ 371 Date: Mar. 25, 2023

(30) Foreign Application Priority Data
Oct. 6, 2020 (DE) 10 2020 212 567.8

(51) Int. Cl. F01D 11/22; F01D 25/16

(52) U.S. Cl. CPC F01D 11/22; F01D 25/168; F05D 2260/406; F05D 2240/52; F05D 2270/64

(57) ABSTRACT

A bearing, a gas turbine unit having such a bearing, and a method for operating and for increasing the efficiency a gas turbine unit, wherein the bearing has an annular bearing body, on the axially opposing end faces of which are provided two thrust bearings, each having a plurality of bearing elements which are distributed over the circumference, project and are movable in the axial direction, and have a bearing surface. The bearing elements of each thrust bearing are hydraulically displaceable axially outwards in two stages by predetermined amounts of movement.

### CROSS REFERENCE TO RELATED APPLICATIONS

This application is the US National Stage of International Application No. PCT/EP2021/074773 filed 9 Sep. 2021, and claims the benefit thereof. The International Application claims the benefit of German Application No. DE 10 2020 212 567.8 filed 6 Oct. 2020. All of the applications are incorporated by reference herein in their entirety.

### FIELD OF INVENTION

The present invention relates to a bearing having an annular bearing body, on the axially opposite end sides of which are provided two thrust bearings, each comprising a plurality of bearing elements which are disposed so as to be distributed over the circumference, project in the axial direction, and have a bearing face. Furthermore, the invention relates to a gas turbine unit having a stator, a rotor which is received in the stator and is mounted so as to be rotatable about a rotation axis, and a plurality of stages of rotor blades held on the rotor and guide vanes held on the stator, wherein at least one bearing of the type mentioned above is provided for mounting the rotor. The invention also relates to a method for increasing the efficiency of a gas turbine unit having a stator, a rotor which is received in the stator and is mounted so as to be rotatable about a rotation axis, and a plurality of stages of rotor blades held on the rotor and guide vanes held on the stator.

### BACKGROUND OF INVENTION

As is known, gas turbine units comprise a stator, a rotor which is received in the stator and mounted so as to be rotatable about a rotation axis, and a plurality of stages of rotor blades held on the rotor and guide vanes held on the stator, said rotor blades and guide vanes during the operation of the gas turbine unit being passed through in a flow direction by an operating medium, as a result of which the operating medium is gradually relieved of pressure and the rotor is driven in a rotating manner. For an efficient operating mode of a gas turbine unit it is of great importance that the gap clearances of radial gaps between the free ends of the rotor blades and the stator are ideally minor in order to avoid flow losses. In this context, there is the issue that the gap clearances of these gaps are not constant but gradually increase when the gas turbine unit is started up from standstill until a stationary operating state is achieved. In order for this issue to be solved, it is known to the applicant that the rotor upon reaching the stationary operating state is displaced relative to the stator counter to the flow direction of the operating medium so as to be able to adjust an ideally minor gap clearance during the stationary operating state and avoid losses in this state. Known in this context are so-called HCO (Hydraulic Clearance Optimization) systems by way of which the rotor can be hydraulically moved relative to the stator between two positions defined by axial detents. However, it is not possible for the rotor to be positioned between these two detents. Moving the rotor beyond one of the detents is also not provided. Accordingly, when reaching the stationary operating state, an HCO system is activated once for displacing the rotor. However, this operating state is established only after several hours, which is why the gas turbine unit can operate efficiently only to a certain extent up to this point. Any earlier activation of the HCO system is likewise impossible because it is necessary to wait for the point in time at which the maximum gap clearance is established, the HCO system being conceived for compensating the latter. Any earlier activation of the HCO system would lead to a collision between the rotor blades and the stator.

### SUMMARY OF INVENTION

Proceeding from this prior art it is an object of the present invention to further improve the efficiency of a gas turbine unit.

For achieving this object, the present invention achieves a bearing having an annular bearing body, on the axially opposite end sides of which are provided two thrust bearings, each comprising a plurality of bearing elements which are disposed so as to be distributed over the circumference, project and are movable in the axial direction, and have a bearing face, wherein each thrust bearing is assigned a first set of hydraulic units having a plurality of hydraulic units which are disposed so as to be distributed over the circumference, are able to be impinged with a uniform pressure, and the pistons of which act on the bearing elements of the corresponding thrust bearing in such a manner that the bearing elements in the axial direction are moved outward by a predetermined uniform first dimension of movement, and wherein each thrust bearing is assigned at least one second set of hydraulic units having a plurality of hydraulic units which are disposed so as to be distributed over the circumference, are able to be impinged with a uniform pressure, and the pistons of which act on the bearing elements of the assigned thrust bearing in such a manner that the bearing elements in the axial direction are additionally moved outward by a predetermined uniform second dimension of movement, wherein each set of hydraulic units is able to be separately activated.

Such a bearing, positioned between two shoulders of the shaft of a rotor, enables the rotor to be moved in a reciprocating manner in two or more stages in the axial direction. Accordingly, the rotor of a gas turbine unit, between starting up the gas turbine unit and reaching the stationary operating state, can be moved at least once to an intermediate position in which radial gap clearances between the rotor blades and the rotor are reduced, as a result of which the efficiency of the gas turbine unit is already significantly increased. When reaching the stationary operating state, the rotor from this intermediate position can then be moved further in the axial direction in order for the optimum gap clearance to be adjusted for this stationary operating state. Of course, the same applies in the reversed order when running down the gas turbine unit.

The hydraulic units of the first set of hydraulic units assigned to one thrust bearing, and the hydraulic units of the second set of hydraulic units assigned to the same thrust bearing, are preferably disposed so as to mutually alternate in the circumferential direction so that the hydraulic units of each set can circumferentially act on the bearing elements and thus on the rotor in an ideally uniform manner. If a further set of hydraulic units is provided, the hydraulic units of the individual sets in the circumferential direction are preferably disposed in such a manner that these sets also form a regularly repeating pattern.

Each set of hydraulic units is preferably assigned a separate oil supply system which has oil ducts that connect the pistons to a hydraulic oil source.

The pistons of the hydraulic units of the first set of hydraulic units assigned to the one thrust bearing, and the pistons of the hydraulic units of the second set of hydraulic units assigned to the same thrust bearing, are in each case advantageously received in a depression of the bearing body and are fixed by a bushing which is inserted into the depression from the outside and fastened to the bearing body, wherein the bearing body and the bushings in the axial direction form detents which define the predetermined first dimension of movement and the predetermined second dimension of movement. For example, the pistons of the hydraulic units of the first set, that are deployable by 1 mm, move the bearing elements by 1 mm. The pistons of the hydraulic cylinders of the other set, that can in each case be deployed by 3 mm, subsequently move the bearing elements positioned on the same end side of the bearing by a further 2 mm.

According to one design embodiment of the present invention, the pistons of the hydraulic units of both sets of hydraulic units assigned to a thrust bearing are in each case received in a depression of the bearing body, wherein the pistons of the hydraulic units of the first set of hydraulic units assigned to this thrust bearing on the free end of said pistons bear on a piston ring which is received on the bearing body and axially movable by the second predetermined dimension of movement, and wherein the pistons of the hydraulic units of the second set of hydraulic units assigned to this thrust bearing at the free end of said pistons bear in each case on a cylindrical pressure element which is guided through an assigned axial through opening of the piston ring and which, when the hydraulic units of the second set of hydraulic units are impinged with pressure, proceeding from a position that does not project axially outward from the piston ring, is moved to a position that projects axially outward from the piston ring by the predetermined first dimension of movement.

The piston ring is preferably received on the bearing body so as to be movable axially in a reciprocating manner between two detents, wherein the piston ring forms a detent for the pistons of the hydraulic units of the second set of hydraulic units. A simple construction is achieved in this way.

According to one design embodiment of the present invention, the bearing on the internal circumference has a radial bearing, as an overall result of which a combined axial/radial bearing is formed.

Furthermore, the present invention achieves a gas turbine unit having a stator, a rotor which is received in the stator and is mounted so as to be rotatable about a rotation axis, and a plurality of stages of the rotor blades held on the rotor and guide vanes held on the stator, characterized in that at least one bearing according to the invention is provided for mounting the rotor.

Moreover, the present invention achieves a stationary gas turbine having a gas turbine unit according to the invention.

Moreover, the present invention achieves a method for increasing the efficiency of a gas turbine unit having a stator, a rotor which is received in the stator and by way of bearings is mounted so as to be rotatable about a rotation axis, and a plurality of stages of rotor blades held on the rotor and guide vanes held on the stator, in particular of a gas turbine unit of a stationary gas turbine in which the rotor in the flow direction of an operating medium flowing through the gas turbine unit is hydraulically movable axially in at least two stages in each case by a predetermined dimension of movement, and in which the rotor counter to the flow direction is hydraulically movable axially in at least two stages, in each case by a predetermined dimension of movement, in particular while using a bearing according to the invention.

According to one design embodiment of the method according to the invention, in the context of starting up the gas turbine unit, the bearing elements of a thrust bearing disposed on an end side of a bearing in the axial direction are moved by a predetermined uniform first dimension of movement in such a manner that the rotor relative to the stator is moved counter to the flow direction of a operating medium flowing through the gas turbine unit by the predetermined first dimension of movement and, when reaching a predetermined operating state, the bearing elements of the same thrust bearing in the axial direction are moved by a predetermined uniform second dimension of movement in such a manner that the rotor relative to the stator is moved further counter to the flow direction by the predetermined second dimension of movement.

In the context of running down the gas turbine unit, bearing elements of a thrust bearing disposed on the opposite end side of the same bearing in the axial direction are preferably moved by a predetermined uniform second dimension of movement in such a manner that the rotor relative to the stator is moved in the flow direction by the predetermined second dimension of movement and, when reaching a predetermined operating state, bearing elements disposed on the same end side of the same thrust bearing in the axial direction are moved further by a predetermined uniform first dimension of movement in such a manner that the rotor relative to the stator is moved further in the flow direction by the predetermined first dimension of movement.

### BRIEF DESCRIPTION OF THE DRAWINGS

Further advantages and features of the present invention will become evident by means of the description hereunder with reference to the appended drawing, in which:

FIG. 1 shows a longitudinal sectional view of a stationary gas turbine according to an embodiment of the present invention;

FIG. 2 shows an enlarged view of the fragment identified by the reference sign II in FIG. 1, which shows a bearing according to an embodiment of the present invention;

FIG. 3 shows a perspective view of the bearing shown in FIG. 2;

FIG. 4 shows a perspective view of the bearing shown in FIG. 3, in which an element carrier supporting bearing elements has been removed;

FIG. 5 shows a view of an end side of the assembly illustrated in FIG. 4;

FIG. 6 shows a sectional view along the line VI-VI in FIG. 5;

FIG. 7 shows a sectional view along the line VII-VII in FIG. 5;

FIG. 8 shows a perspective sectional view of the assembly shown in FIG. 7;

FIG. 9 shows an end view of the assembly illustrated in FIG. 4 from the other side, wherein an element carrier receiving bearing elements has also been removed here;

FIG. 10 shows a sectional view along the line X-X in FIG. 9;

FIG. 11 shows a perspective sectional view of the assembly illustrated in FIG. 10;

FIG. 12 shows a sectional view along the line XII-XII in FIG. 9;

FIG. 13 shows an end view of the assembly illustrated in FIG. 4, which by way of example shows the positioning of oil ducts of an oil supply system; and

FIG. 14 shows a sectional view of the assembly shown in FIG. 13.

### DETAILED DESCRIPTION OF INVENTION

The same reference signs hereunder identify identical or equivalent components.

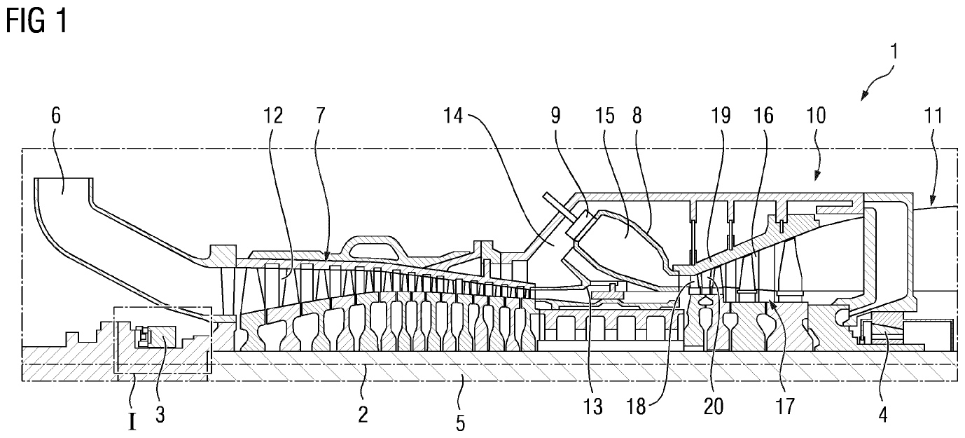

FIG. 1 shows a stationary gas turbine 1 having a rotor 5 which by way of bearings 3 and 4 is mounted so as to be rotatable about a rotation axis 2 and along which are positioned in succession an intake housing 6, a compressor 7, a toroidal annular combustion chamber 8 having a plurality of burners 9 which are disposed so as to be mutually rotationally symmetrical, a gas turbine unit 10 and an exhaust gas housing 11. The compressor 7 comprises an annularly configured compressor duct 12 having therein cascading compressor stages of rotor blade rings and guide vane rings. The compressor duct 12 by way of a compressor exit diffuser 13 opens into a plenum 14. Provided therein is the annular combustion chamber 8 having the combustion chamber 15 thereof, which communicates with an annular hot gas duct 16 of the turbine unit 10. Disposed in the turbine unit 10 are four successively disposed turbine stages 17 which are in each case formed by a ring of rotor blades 18 held on the rotor and guide vanes held on the stator 19 that surrounds the rotor 5. A generator, not illustrated in more detail, or a work machine, not illustrated in more detail, is presently coupled to the rotor 5.

During the operation of the stationary gas turbine 1, the compressor 7 by way of the intake housing 6 suctions ambient air, which is compressed in the compressor 7. The compressed air by way of the compressor exit diffuser 13 is guided into the plenum 14 from where said compressed air flows into the burners 9. Fuel by way of the burners 9 also makes its way into the combustion chamber 15. In the latter, the fuel with the addition of the compressed air is combusted so as to form a hot gas which forms the operating medium of the gas turbine unit 10. The hot gas subsequently flows into the hot gas duct 16 where said hot gas relaxes so as to perform work on the turbine blades of the turbine unit 10. The energy released in the process is received in the rotor 5 and utilized for driving the compressor 7, on the one hand, and for driving the generator or the work machine, on the other hand.

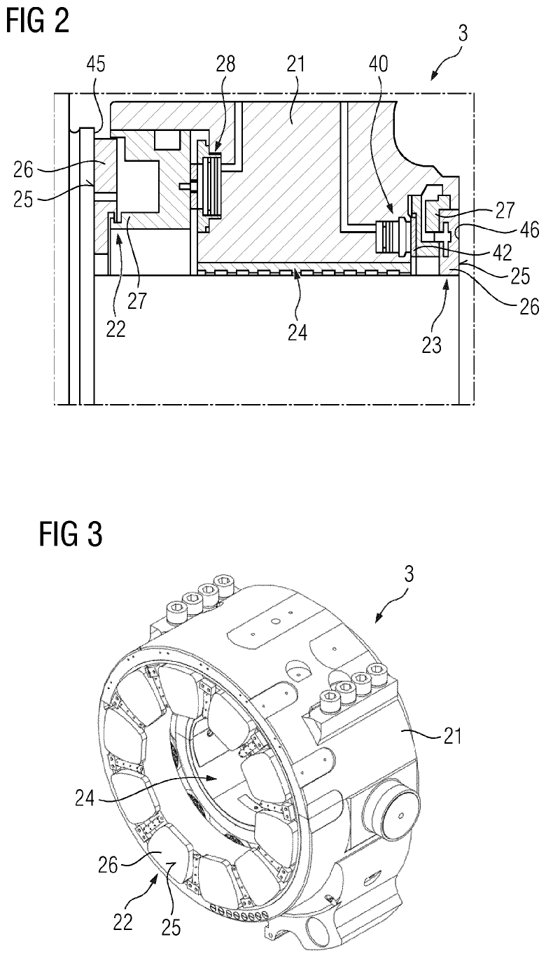

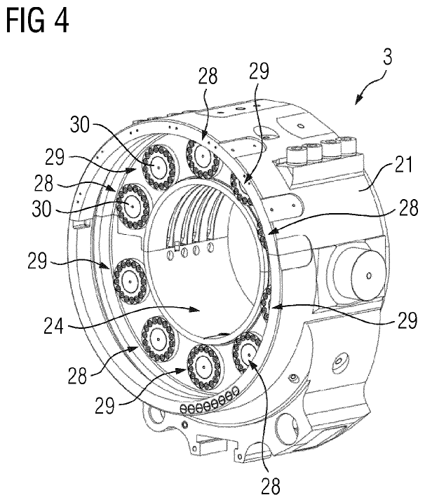

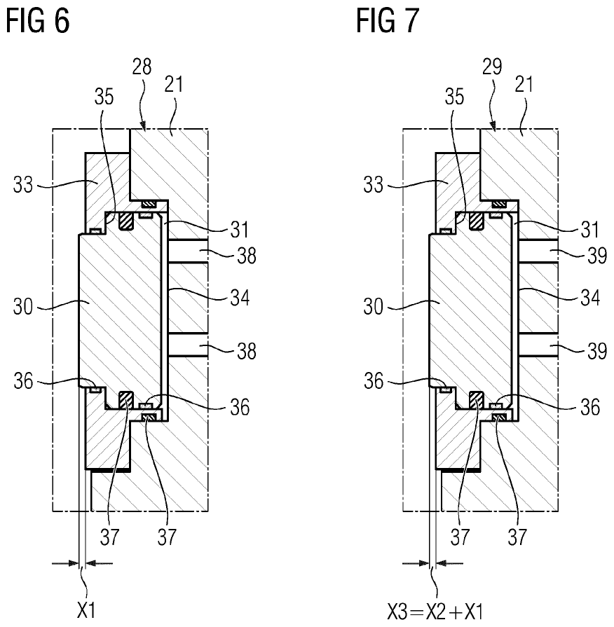

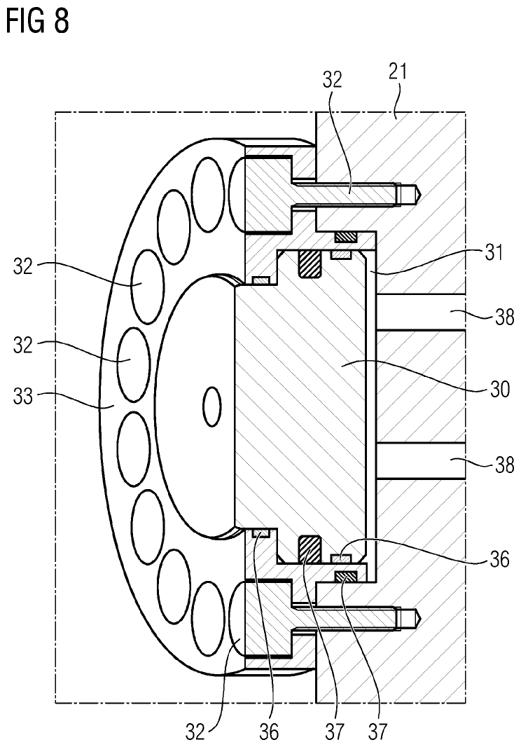

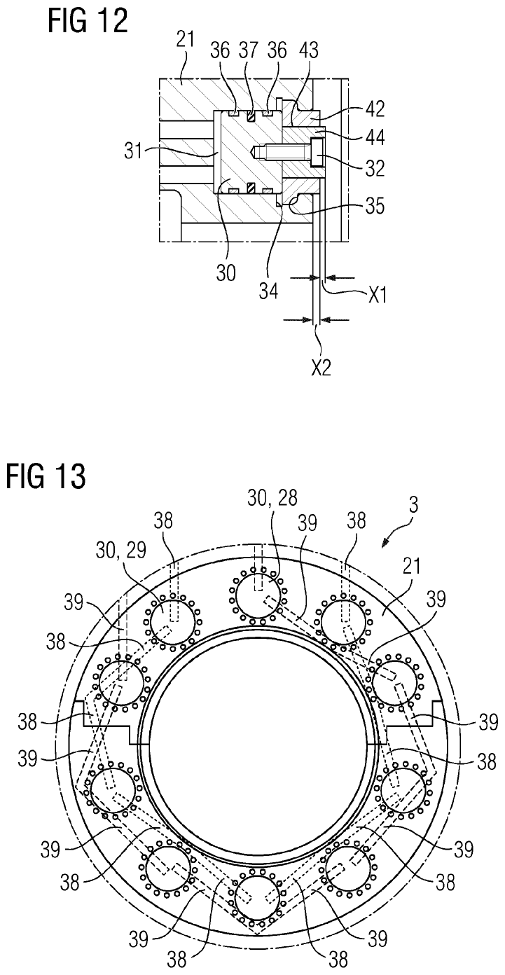

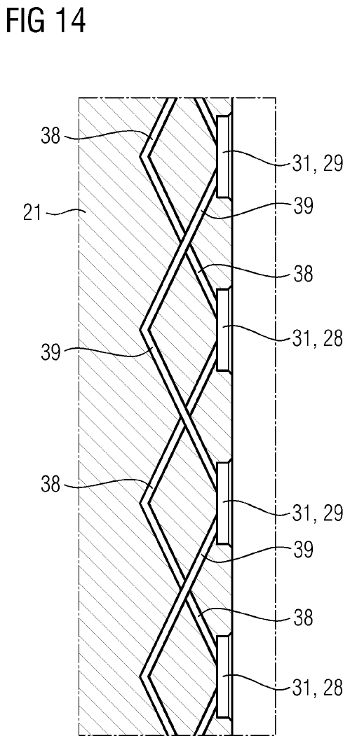

As has already been explained at the outset, it is of great importance for an efficient operating mode of the stationary gas turbine 1, or of the gas turbine unit 10 thereof, that the gap clearances of radial gaps between the free ends of the rotor blades 18 and the stator 19 are ideally minor so as to avoid flow losses. Since the gap clearances in the context of starting up the stationary gas turbine 1 gradually increase until a stationary operating state is reached, it is desirable that this enlargement of the gap clearances is compensated for by a relative movement between the rotor 5 and the stator 19. This relative movement is presently implemented by the compressor-proximal bearing 3 which on the external side is fixedly connected to the stator 19 and is illustrated in FIGS. 2 to 13.

The bearing 3 comprises an annular bearing body 21 which presently is assembled from a lower and an upper bearing body shell. Two thrust bearings 22, 23 are provided at the mutually opposite end sides of the bearing body 21. A radial bearing 24 is positioned on the internal circumference of the bearing 3. Each of the two thrust bearings 22 and 23 comprises a plurality of bearing elements 26 which are disposed so as to be distributed over the circumference, project in the axial direction A, have a bearing face 25 and which are in each case disposed on an element carrier 27 which is movable axially in a reciprocating manner.

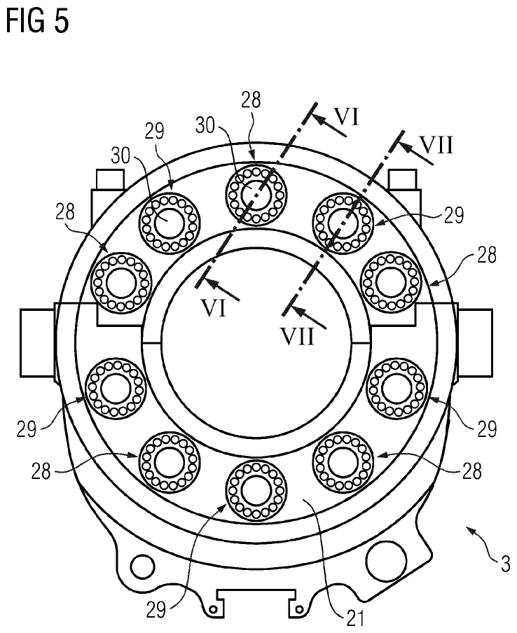

The thrust bearing 22 of the bearing 3, which in FIG. 2 points toward the left and presently forms the so-called primary track and is illustrated in more detail in FIGS. 5 to 8, comprises two sets of hydraulic units which are fed independently of one another by way of separate oil supply systems. The hydraulic units 28 of the first set and the hydraulic units 29 of the second set are of a fundamentally identical construction. Said hydraulic units 28, 29 comprise in each case a piston 30 which is received in a depression 31 of the bearing body 21 that extends in the axial direction A and fixed by way of a bushing 33 which is inserted into the depression 31 from the outside and presently fastened on the bearing body 21 by fastening screws 32. The bearing body 21 and the respective associated bushing 33 in the axial direction A form in each case detents 34 and 35 between which the piston 30 in the axial direction A is movable in a reciprocating manner by a predetermined dimension of movement. The guiding of the piston 30 within the bushing 33 is performed by way of guide rings 36. The sealing of the bushing 33 in relation to the bearing body 21 and of the piston 30 in relation to the bushing 33 is performed by annular seals 37. The substantial difference between the hydraulic units 28 of the first set and the hydraulic units 29 of the second set of hydraulic units lies in that the predetermined dimension of movement X by which the pistons 30 can be moved in a reciprocating manner in the axial direction A differs. Presently, the predetermined first dimension of movement X1 by which the pistons 30 of the hydraulic units 28 of the first set in the deployed state project axially outward beyond the associated bushings 33 is smaller than a predetermined second dimension of movement X2 by which the pistons 30 of the hydraulic units 29 of the second set in the deployed state project axially outward beyond the associated bushings 33, wherein the free ends of all of the bushings are positioned in a common plane perpendicular to the axial direction A. In this way, the predetermined first dimension of movement X1 presently is 1 mm, and a third predetermined dimension of movement X3 is 3 mm so that, when the pistons 30 of all hydraulic units 28 and 29 are deployed, the pistons 30 or hydraulic cylinders project from the hydraulic units by the predetermined dimension of movement X2=2 mm. As can be best seen in FIG. 5, the hydraulic units 28 of the first set of hydraulic units, and the hydraulic units 29 of the second set of hydraulic units, are disposed so as to mutually alternate in the circumferential direction. FIG. 13 shows that the oil ducts 38, which supply the hydraulic units 28 of the first set with hydraulic oil, are in each case connected to one another, as a result of which all of the hydraulic units 28 of the first set can be simultaneously impinged with a uniform pressure. In an analogous manner, all of the oil ducts 39, which supply the hydraulic units 29 of the second set of hydraulic units with hydraulic oil, are connected to one another so that the hydraulic units 29 can also be simultaneously impinged with a uniform pressure. However, the two sets of hydraulic units are not connected to one another by way of oil ducts.

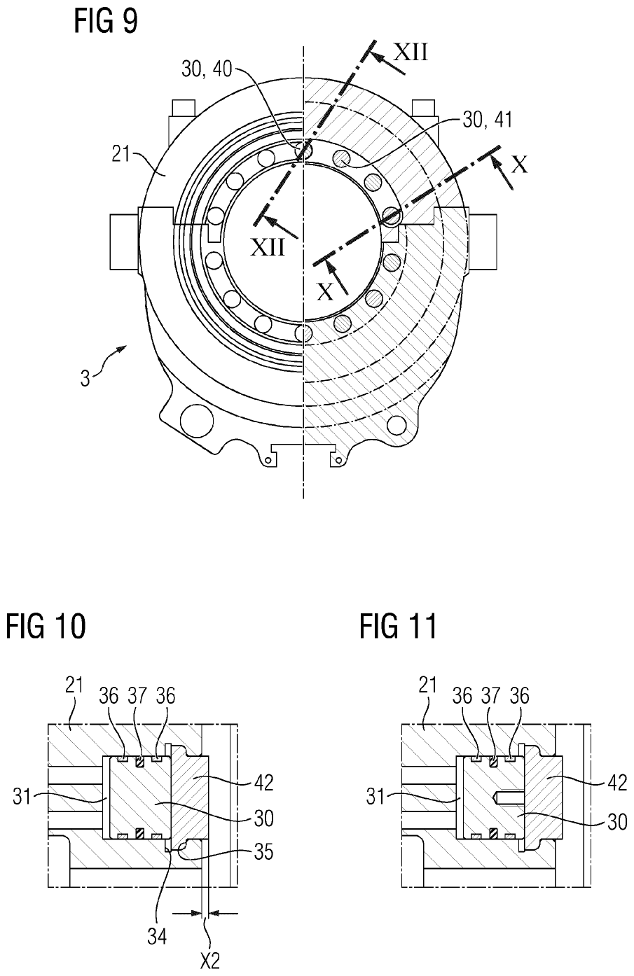

The thrust bearing 23 of the bearing 3, which in FIG. 2 points toward the right and presently forms the so-called secondary track and is illustrated in more detail in FIGS. 9 to 12, likewise comprises two sets of hydraulic units which are fed independently of one another by way of separate oil supply systems, the hydraulic units 40, 41 thereof being again disposed so as to alternate in the circumferential direction, as is shown in FIG. 9. The pistons 30 of the hydraulic units 40 and 41 of both sets are in each case received in depressions 31 of the bearing body 21 that extend in the axial direction A, guided by way of guide rings 36 and sealed by way of annular seals 37. The pistons of the hydraulic units 40 of the first set of hydraulic units on the free end thereof bear on a piston ring 42 which is received on the bearing body 21 so as to be movable axially in a reciprocating manner between two detents 34 and 35 that define the predetermined second dimension of movement X2 of the piston ring 42, which is 2 mm. The pistons 30 of the hydraulic units 41 of the second set of hydraulic units on the free end thereof are in each case connected to a cylindrical pressure element 44 which is guided through an assigned axial through opening 43 of the piston ring 42 and which, when the hydraulic units 41 of the second set of hydraulic units are impinged with pressure, proceeding from a position that does not project axially outward from the piston ring 42, by way of the pistons 30 is moved to a position that project axially outward from the piston ring 42 by the predetermined first dimension of movement X1, the first dimension of movement X1 here too being 1 mm. The latter position here is determined by the piston ring 42 which serves as a detent for the pistons 30 of the hydraulic units 41 of the second set. While this is presently not shown, the oil ducts that supply the hydraulic units 40 of the first set with hydraulic oil are in each case connected to one another, as a result of which all of the hydraulic units 40 of the first set can be simultaneously impinged with a uniform pressure. In an analogous manner, all of the oil ducts which supply the hydraulic units 41 of the second set of hydraulic units with hydraulic oil are connected to one another so that the hydraulic units 41 can also be simultaneously impinged with a uniform pressure. However, the two sets of hydraulic units are not connected to one another by way of oil ducts.

In the assembled state, the bearing 3 is positioned between two rotor shoulders 45 and 46, see FIG. 2. When starting up the stationary gas turbine, the hydraulic units 40 and 41 of the right thrust bearing 23 are impinged with hydraulic pressure, while the hydraulic units 28 and 29 of the left thrust bearing 22 are not pressurized. Accordingly, the piston ring 42 as well as the pressure elements 44 are in the fully deployed state so that the pressure elements 44 by way of the assigned element carrier 27 and the bearing elements held on the latter exert pressure on the rotor shoulder 46. Accordingly, the rotor 5 is positioned in the extreme right position thereof. Upon reaching a first operating state, the latter being established for example after half the time required for reaching a stationary operating state, the hydraulic units 41 of the second set of hydraulic units of the right thrust bearing 23 are depressurized, and the hydraulic units 28 of the first set of hydraulic units of the left thrust bearing 22 are impinged with pressure. The pistons 30 of the hydraulic units 28 by way of the assigned element carrier 27 and the bearing elements 26 held thereon correspondingly press against the rotor shoulder 45 so that the rotor 5 relative to the stator 19 is pressed toward the left, counter to the flow direction of the operating medium flowing through the gas turbine unit 10, by the predetermined first dimension of movement X1. In this way, the gap clearances of the radial gaps between the rotor blades 18 of the gas turbine unit 10 and the stator 19, which have increased since the gas turbine unit 10 has been started, are reduced again. When reaching the stationary operating state, the hydraulic units 40 of the first set of hydraulic units of the right thrust bearing 23 are depressurized, and the hydraulic units 29 of the second set of hydraulic units of the left thrust bearing 22 are impinged with pressure. The pistons 30 of the hydraulic units 29 by way of the assigned element carrier 27 and the bearing elements 26 held thereon correspondingly press against the rotor shoulder 45 so that the rotor 5 relative to the stator 19 is pressed toward the left by the predetermined second dimension of movement X2. In this way, the gap clearances which have yet again increased from the first operating state having been reached until the stationary operating state has been reached, are yet again reduced. In this way, an overall highly efficient operating mode of the gas turbine unit 10 is ensured. When the gas turbine unit 10 is run down again, the stator is moved in an analogous manner in the flow direction of the operating medium flowing through the gas turbine unit first by the predetermined dimension X2 and then by the predetermined dimension X1. Here too, a highly efficient operating mode is achieved.

It ought to be obvious that the predetermined dimensions of movement X1 and X2 can in principle be arbitrarily chosen. It should also be obvious that the operating states, upon reaching which the rotor 5 is moved relative to the stator 19, are freely selectable. The predetermined dimensions of movement X1 and X2 have only to be adapted to the gap clearances that result in the operating states.

While the invention has been illustrated and described in more detail by the preferred exemplary embodiment, the invention is not limited by the disclosed examples, and other variations can be derived therefrom by the person skilled in the art without departing from the scope of protection of the invention.

1. A bearing, comprising:
an annular bearing body, on axially opposite end sides of which are provided two thrust bearings, each comprising a plurality of bearing elements which are disposed so as to be distributed over a circumference, project and are movable in an axial direction, and have a bearing face;
wherein each thrust bearing is assigned a first set of hydraulic units having a plurality of hydraulic units which are disposed so as to be distributed over the circumference, are able to be impinged with a uniform pressure, and pistons of which act on the bearing elements of a corresponding thrust bearing in such a manner that the bearing elements in the axial direction are moved outward by a predetermined uniform first dimension of movement; and
wherein each thrust bearing is assigned at least one second set of hydraulic units having a plurality of hydraulic units which are disposed so as to be distributed over the circumference, are able to be impinged with a uniform pressure, and the pistons of which act on the bearing elements of the assigned thrust bearing in such a manner that the bearing elements in the axial direction are additionally moved outward by a predetermined uniform second dimension of movement, wherein each set of hydraulic units is able to be separately activated.

2. The bearing as claimed in claim 1,
wherein the hydraulic units of the first set of hydraulic units assigned to one thrust bearing, and the hydraulic units of the second set of hydraulic units assigned to the same thrust bearing, are disposed so as to mutually alternate in a circumferential direction.

3. The bearing as claimed in claim 1,
wherein each set of hydraulic units is assigned a separate oil supply system which has oil ducts that connect the pistons to a hydraulic oil source.

4. The bearing as claimed in claim 1,
wherein the pistons of the hydraulic units of the first set of hydraulic units assigned to one thrust bearing, and the pistons of the hydraulic units of the second set of hydraulic units assigned to the same thrust bearing, are in each case received in a depression of the annular bearing body and are fixed by a bushing which is inserted into the depression from an outside and fastened to the annular bearing body;
wherein the annular bearing body and the bushings in the axial direction form detents which define the predetermined first dimension of movement and the predetermined second dimension of movement.

5. The bearing as claimed in claim 1,
wherein the pistons of the hydraulic units of both sets of hydraulic units assigned to a thrust bearing are in each case received in a depression of the annular bearing body;
wherein the pistons of the hydraulic units of the first set of hydraulic units assigned to this thrust bearing on a free end of said pistons bear on a piston ring which is received on the annular bearing body and axially movable by the predetermined second dimension of movement; and
wherein the pistons of the hydraulic units of the second set of hydraulic units assigned to this thrust bearing at the free end of said pistons are in each case connected to a cylindrical pressure element which is guided through an assigned axial through opening of the piston ring and which, when the hydraulic units of the second set of hydraulic units are impinged with pressure, proceeding from a position that does not project axially outward from the piston ring, is moved to a position that projects axially outward from the piston ring by the predetermined first dimension of movement.

6. The bearing as claimed in claim 5,
wherein the piston ring is received on the annular bearing body so as to be movable axially in a reciprocating manner between two detents; and
wherein the piston ring forms a detent for the pistons of the hydraulic units of the second set of hydraulic units.

7. The bearing as claimed in claim 1,
wherein said bearing on an internal circumference has a radial bearing.

8. A gas turbine unit, comprising:
a stator,
a rotor which is received in the stator and is mounted so as to be rotatable about a rotation axis, and
a plurality of stages of rotor blades held on the rotor and guide vanes held on the stator,
wherein at least one bearing as claimed in claim 1 is provided for mounting the rotor.

9. A stationary gas turbine, comprising:
a gas turbine unit as claimed in claim 8.

10. A method for increasing an efficiency of a gas turbine unit having a stator, a rotor which is received in the stator and by way of bearings is mounted so as to be rotatable about a rotation axis, and a plurality of stages of rotor blades held on the rotor and guide vanes held on the stator, the method comprising:
hydraulically moving axially the rotor in a flow direction of an operating medium flowing through the gas turbine unit in at least two stages in each case by a predetermined dimension of movement; and
hydraulically moving axially the rotor counter to the flow in at least two stages.

11. The method as claimed in claim 10,
wherein, when starting up the gas turbine unit, bearing elements of a thrust bearing disposed on an end side of a bearing in the axial direction are moved toward the rotor by a predetermined uniform first dimension of movement in such a manner that the rotor relative to the stator is moved counter to the flow direction by the predetermined first dimension of movement and,
when reaching a predetermined operating state, bearing elements of the same thrust bearing in the axial direction are moved toward the rotor by a predetermined uniform second dimension of movement in such a manner that the rotor relative to the stator is moved further counter to the flow direction by the predetermined second dimension of movement.

12. The method as claimed in claim 11,
wherein, when running down the gas turbine unit, bearing elements of a thrust bearing disposed on the opposite end side of the same bearing in the axial direction are moved by a predetermined uniform second dimension of movement in such a manner that the rotor relative to the stator is moved in the flow direction by the predetermined second dimension of movement and,
when reaching a predetermined operating state, bearing elements of the same thrust bearing in the axial direction are moved further by a predetermined uniform first dimension of movement in such a manner that the rotor relative to the stator is moved further in the flow direction by the predetermined first dimension of movement.

13. The method as claimed in claim 10,
wherein the gas turbine unit is of a stationary gas turbine.
